(19) United States
(12) Patent Application Publication
(10) Pub. No.: US 2024/0015115 A1
(43) Pub. Date: Jan. 11, 2024

(54) SYSTEMS, METHODS, AND DEVICES FOR INTERCONNECTING NETWORK DEVICES

(71) Applicant: MELLANOX TECHNOLOGIES, LTD., Yokneam (IL)

(72) Inventor: Shai Cohen, Haifa (IL)

(21) Appl. No.: 17/862,068

(22) Filed: Jul. 11, 2022

(51) Int. Cl. H04L 49/15; H04L 49/253; H04L 49/00

(52) U.S. Cl. CPC H04L 49/15; H04L 49/253; H04L 49/30

(57) ABSTRACT

An apparatus for interconnecting devices in a network comprises a connection interface with a first face and a second face opposite the first face. The apparatus includes a first 2D array of first connection points arranged on the first face of the connection interface. Each first connection point in each column of the first 2D array connects to a different host device from among a plurality of host devices, and each first connection point in each row of the first 2D array connects to a single host device from among the plurality of host devices. A second 2D array of second connection points is arranged on the second face of the connection interface. Each second connection point is connected to a respective first connection point, each second connection point in each column of the second 2D array connects to a single network switch from among a plurality of network switches, and each second connection point in each row of the second 2D array connects to a different network switch from among the plurality of network switches.

### FIELD OF THE DISCLOSURE

The present disclosure is generally directed to systems, methods, and devices for interconnecting network devices.

### BACKGROUND

Servers and network switches are used in networking systems, like datacenters, for processing and routing data. The servers may be connected to the network switches through electrical cables and/or optical cables.

### BRIEF SUMMARY

In an illustrative embodiment, an apparatus for interconnecting devices in a network comprises a panel comprising a first face and a second face opposite the first face; first connection points arranged on the first face of the panel in a first direction, wherein each first connection point is connectable to a corresponding port of a single host device; and second connection points arranged on the second face of the panel in the first direction, wherein each second connection point is connected to a respective first connection point, and wherein each second connection point is connectable to a corresponding port of a different network switch in a plurality of network switches that route traffic for the single host device.

In another illustrative embodiment, an apparatus for interconnecting devices in a network comprises a connection interface comprising a first face and a second face opposite the first face; a first 2D array of first connection points arranged on the first face of the connection interface, wherein each first connection point in each column of the first 2D array connects to a different host device from among a plurality of host devices, and wherein each first connection point in each row of the first 2D array connects to a single host device from among the plurality of host devices; and a second 2D array of second connection points arranged on the second face of the connection interface, wherein each second connection point is connected to a respective first connection point, wherein each second connection point in each column of the second 2D array connects to a single network switch from among a plurality of network switches, and wherein each second connection point in each row of the second 2D array connects to a different network switch from among the plurality of network switches.

In another illustrative embodiment, an apparatus for interconnecting devices in a network comprising a host device; network switches that route traffic for the host device; a housing that houses the host device and the network switches; a panel in the housing and positioned between the host device and the network switches, the panel comprising a first face and a second face opposite the first face; first connection points arranged on the first face of the panel in a first direction, wherein each first connection point is connectable to a corresponding port of the host device; second connection points arranged on the second face of the panel in the first direction, wherein each second connection point is connected to a respective first connection point, and wherein each second connection point is connectable to a corresponding port of a different network switch in the network switches.

It should be appreciated that inventive concepts cover any embodiment in combination with any one or more other embodiments, any one or more of the features disclosed herein, any one or more of the features as substantially disclosed herein, any one or more of the features as substantially disclosed herein in combination with any one or more other features as substantially disclosed herein, any one of the aspects/features/embodiments in combination with any one or more other aspects/features/embodiments, use of any one or more of the embodiments or features as disclosed herein. It is to be appreciated that any feature described herein can be claimed in combination with any other feature(s) as described herein, regardless of whether the features come from the same described embodiment.

Additional features and advantages are described herein and will be apparent from the following description and the figures.

### BRIEF DESCRIPTION OF THE DRAWINGS

The present disclosure is described in conjunction with the appended figures, which are not necessarily drawn to scale:

FIG. 1 illustrates a block diagram of a networking system according to at least one example embodiment;

FIG. 2 illustrates a networking topology according to at least one example embodiment;

FIG. 3A illustrates a schematic plan view of an apparatus for interconnecting devices in a network according to at least one example embodiment;

FIG. 3B illustrates another view of the apparatus for interconnecting devices in FIG. 3A according to at least one example embodiment; and

FIG. 4 illustrates a schematic plan view of an apparatus for interconnecting devices in a network according to at least one example embodiment.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or optical links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a PCB, or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The terms “determine,” “calculate,” and “compute,” and variations thereof, as used herein, are used interchangeably and include any appropriate type of methodology, process, operation, or technique.

Various aspects of the present disclosure will be described herein with reference to drawings that may be schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “include,” “including,” “includes,” “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

In some datacenter implementations, host devices, such as servers, and routing devices, such as network switches, are incorporated into the same chassis or rack, which leads to complicated cabling and interconnections, transmission latencies as a result of mismatched transmission line lengths between each host device and each network switch, signal degradation as a result of lengthy transmission lines (cables), and/or risk of mechanical damage to fiber optic components (e.g., fibers breaking in the chassis). Inventive concepts propose to address these and other problems in the field with a connection interface having a 2D connection matrix that interconnects N host devices to M parallel networks (where N and M are integers) in a manner that reduces cabling complexity, latency mismatches, and/or signal degradation issues that plague the related art. The connection interface may comprise a panel with a 2D array of connectors that connect to host devices on one side and with a 2D array of connectors that connect to routing devices on the other side.

For example, at least one embodiment is directed to an interface that comprises a panel of a chassis with a 2D array of connection points on a front of the panel that connect to host devices (e.g., servers) and with a 2D array of connection points on a back of the panel that connect to routing devices, such as network switches (e.g., Ethernet switches). The connection points may comprise suitable electrical and/or optical connectors that connect to the host devices and the routing devices. Each connector on the front of the panel is connected (e.g., electrically and/or optically connected) to a respective connector on the back of the panel. In one example, each row of connectors in the 2D array on the front of the panel connects to a respective host device while each column of connectors in the 2D array on the back of the panel connects to a respective routing device. Alternatively, each column of connectors in the 2D array on the front of the panel connects to a respective host device while each row of connectors in the 2D array on the back of the panel connects to a respective routing device. In some embodiments, the panel is a front panel of the chassis or rack. In other embodiments, the panel is internally located within the chassis or rack. As may be appreciated, a panel with connectors arranged according to one of the above configurations simplifies cabling for the chassis or rack compared to the related art. In addition, the panel enables use of relatively uniform cable lengths between a respective host device and the routing devices, which reduces signal degradation and/or mismatched transmission latencies that plague the related art.

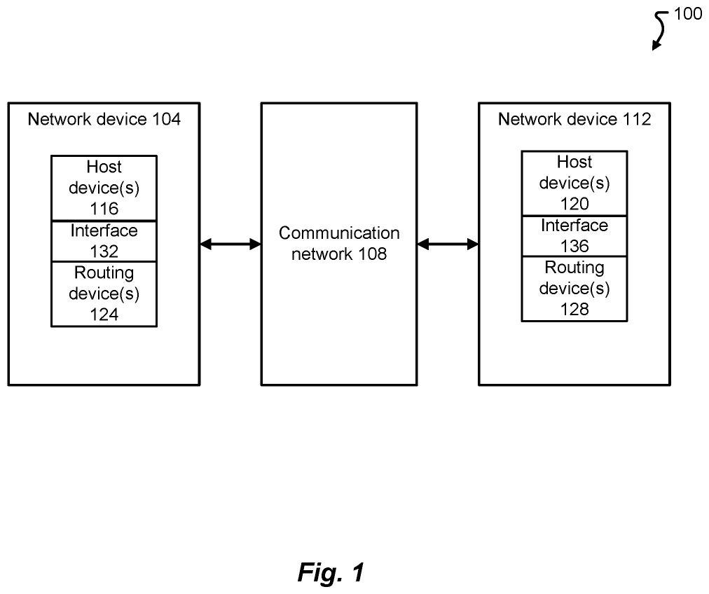

FIG. 1 illustrates a system 100 according to at least one example embodiment. The system 100 includes a network device 104, a communication network 108, and a network device 112. In one non-limiting embodiment, network devices 104 and 112 each comprise a chassis or rack that contains respective host devices 116 and 120 and respective routing devices 124 and 128. A host device may correspond to or include a server, a collection or servers, or any other suitable device used for processing data transmitted over the communication network 108. A routing device may correspond or include a network switch (e.g., an Ethernet switch), a collection of network switches, or any other suitable device used to route data between devices connected to communication network 108. Each network device 104 and 112 may be connected to and exchange data with an end user device such as one or more of Personal Computer (PC), a laptop, a tablet, a smartphone, and/or the like.

As shown in FIG. 1, host devices and routing devices in each network device 104 and 112 may be mechanically and electrically (or optically) coupled to one another by a respective connection interface 132 and 136. As discussed in more detail herein, a connection interface may comprise a panel with a 2D array of connection points on one face of the panel that connect to host devices and with another 2D array of connection points on an opposing face of the panel that connect to routing devices.

Examples of the communication network 108 that may be used to connect the network devices 104 and 112 include an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like. In one specific, but non-limiting example, the communication network 108 is a network that enables communication between the network devices 104 and 112 using Ethernet technology. In one specific, but non-limiting example, the network devices 104 and 112 may implement multiple layers of a network topology within a single chassis.

Although not explicitly shown, the network device 104 and/or the network device 112 may include storage devices and/or processing circuits for carrying out computing tasks, for example, tasks associated with controlling the flow of data within each network device 104 and 112 and/or over the communication network 108. Such processing circuits may comprise software, hardware, or a combination thereof. For example, the processing circuits may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally or alternatively, the processing circuits may comprise hardware, such as an application specific integrated circuit (ASIC). Other non-limiting examples of processing circuits include an Integrated Circuit (IC) chip, a Central Processing Unit (CPU), a Graphics Processing Unit (GPU), a microprocessor, a Field Programmable Gate Array (FPGA), a collection of logic gates or transistors, resistors, capacitors, inductors, diodes, or the like. Some or all of the processing circuits may be provided on a Printed Circuit Board (PCB) or collection of PCBs. It should be appreciated that any appropriate type of electrical component or collection of electrical components may be suitable for inclusion in the processing circuits.

In addition, although not explicitly shown, it should be appreciated that the network devices 104 and 112 include one or more communication interfaces for facilitating wired and/or wireless communication between one another and other unillustrated elements of the system 100.

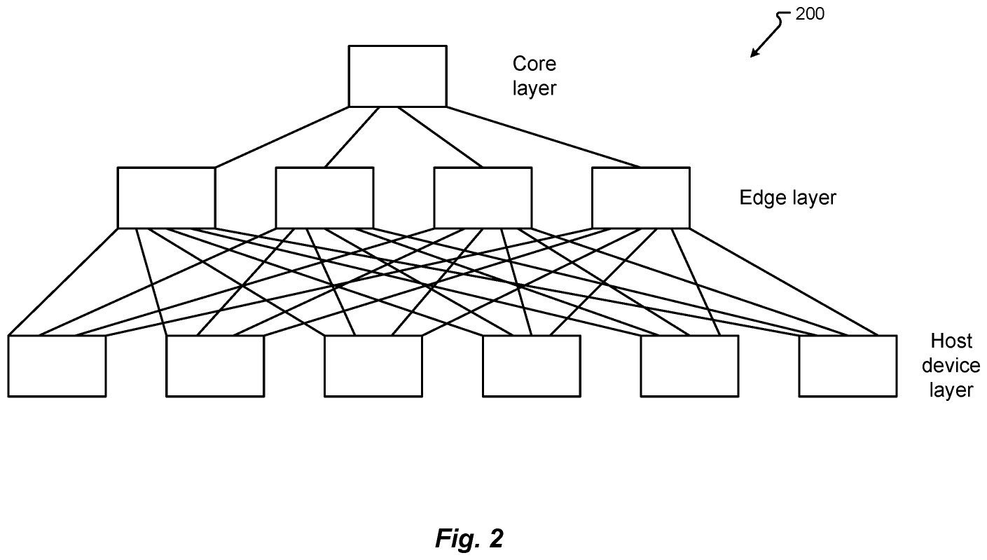

FIG. 2 illustrates a networking topology 200 according to at least one example embodiment. The topology 200 is a two tier topology with core and edge layers connected to a host device layer. Each box in the host device layer may include or correspond to a host device that is the same as or similar to host devices 116 and/or 120 from FIG. 1 (e.g., servers). Each box of the core and edge layers represents a routing device or collection of routing devices similar to or the same as routing devices 124 and 128 from FIG. 1 (e.g., network switches). Here, it should be appreciated that example embodiments are not limited to the topology 200, and inventive concepts may be applied to other suitable network topologies (e.g., a three tier topology with core, aggregation, and edge layers connected to a host device layer and/or a single tier topology with an edge layer connected to a host device layer). As discussed in more detail below, example embodiments relate to a connection interface that, for example, connects host devices in the host device layer with network switches in the edge layer.

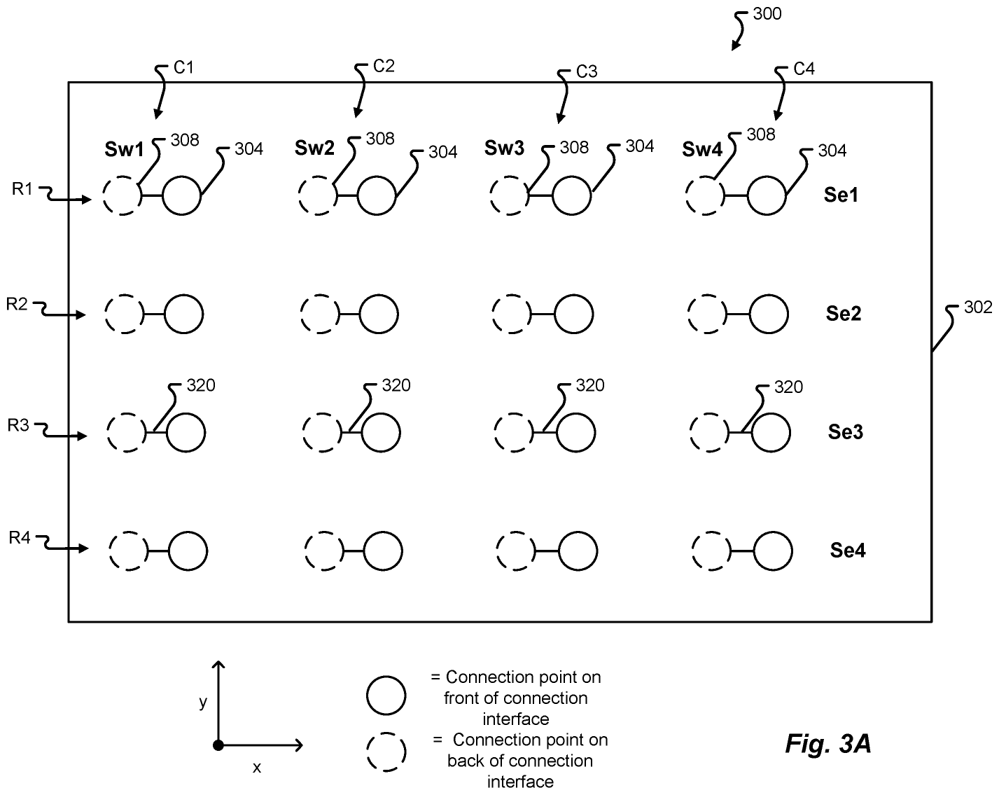

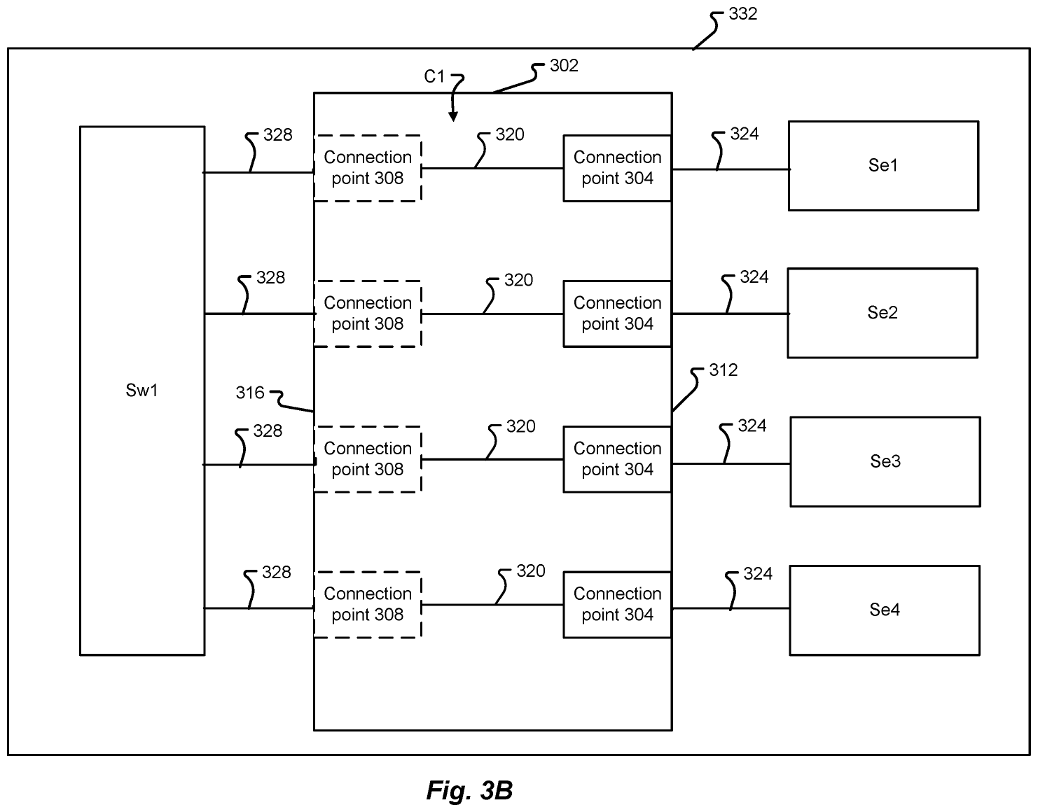

FIG. 3A illustrates a schematic plan view of an apparatus for interconnecting devices in a network according to at least one example embodiment. FIG. 3B illustrates another schematic view of the apparatus for interconnecting devices in FIG. 3A according to at least one example embodiment. With reference to FIGS. 3A and 3B, the apparatus for interconnecting devices may comprise a connection interface 300 that corresponds to the connection interface 132 and/or 136 in FIG. 1 to connect host devices to routing devices housed within a single chassis. In at least one embodiment, the connection interface 300 comprises a panel 302. The panel 302 may be substantially planar and comprise a first face or surface 312 and a second face or surface 316 opposite the first face. The panel 302 may be made of a suitable material, such as rigid plastic polymer. As shown, a first 2D array of first connection points 304 may be arranged on the first face 312 (e.g., front face) of the panel 302 while a second 2D array of second connection points 308 may be arranged on the second face 316 (e.g., back face) of the panel 302. For ease of illustration, only one row of connection points 304 and 308 is labeled in FIG. 3A. The arrays are arranged in columns C1 to C4 and in rows R1 to R4. However, more or fewer rows and/or columns of connection points 304 and 308 may be used.

FIGS. 3A and 3B further illustrate a plurality of interconnects 320 that connect the first connection points 304 to the second connection points 308 so that each interconnect 320 connects a first connection point 304 to a second connection point 308 (only one row of interconnects 320 labeled in FIG. 3A). In at least one embodiment, the plurality of interconnects 320 pass through the panel 302 (see FIG. 3B). The plurality of interconnects may comprise electrical interconnects (e.g., conductive wires, conductive traces), optical interconnects (e.g., optical fibers, waveguides), or a combination of electrical interconnects and optical interconnects. The plurality of interconnects 320 may have substantially the same lengths.

As shown in FIG. 3A, the first connection points 304 in each row of the 2D array of first connection points are aligned with one another in a first direction (e.g., x-direction). The second connection points 308 in each row of the 2D array of second connection points are also aligned with another in the first direction. In addition, the first connection points 304 in each column of the 2D array of first connection points are aligned with one another in a second direction, substantially perpendicular to the first direction (e.g., y-direction). The second connection points 308 in each column of the 2D array of second connection points are also aligned with one another in the second direction.

In at least one embodiment, the first connection points 304 and the second connection points 308 are arranged on the panel 302 such that each of the plurality of interconnects 320 travels a minimum distance between a respective first connection point and a respective second connection point. For example, the 2D array of the first connection points 304 and the 2D array of the second connection points 308 are arranged on the panel 300 to overlap one another in a plan view (FIG. 3A illustrates second connection points 308 as being offset from connection points 304 for the sake showing all connection points on the back and front of the panel 302 in one figure). Stated another way, each pair of connection points 304 and 308 connected by an interconnect 320 partially or completely overlap in a top view of the panel 302 (see side view of panel 302 in FIG. 3B where connection points 304 and 308 are substantially aligned with one another in a horizontal direction, meaning that they overlap with one another in the plan view). In one embodiment and still with reference to FIG. 3B, a central axis of a connection point 304 (e.g., a connector) aligns with a central axis of a connection point 308 (e.g., a connector) in a horizontal direction (i.e., the same direction that an interconnect 320 extends between two connection points 304 and 308). Example embodiments are not limited to the above configurations, however, and the connection points may be offset from one another (e.g., as illustrated in FIG. 3A) if, for example, the arrangement of the servers and network switches in the chassis dictates an offset arrangement or other arrangement of connection points. In at least embodiment, each interconnect 320 has a substantially same length.

The first connection points 304 and the second connection points 308 may comprise electrical connectors, optical connectors, or a combination of electrical connectors and optical connectors. For example, the first connection points 304 may comprise a male and/or female connectors that mechanically and communicatively couple the connection interface 300 to host devices 116 or 120 (e.g., servers). The second connection points 308 may comprise male and/or female connectors that mechanically and communicatively couple the connection interface 300 to routing devices 124 or 128 (e.g., network switches).

In accordance with example embodiments, each first connection point 304 in each column of the 2D array on the face 312 connects to a different host device from among a plurality of host devices, and each first connection point 308 in each row of the 2D array connects to a single host device from among the plurality of host devices. In addition, each second connection point 308 in each column of the 2D array on face 316 connects to a single routing device from among a plurality of routing devices, and each second connection point 308 in each row of the 2D array connects to a different routing device from among the plurality of routing devices. FIGS. 3A and 3B illustrate an example where the host devices are servers Se and the routing devices are network switches Sw.

As shown in FIG. 3A, connection points 304 connect to ports of four servers Se1, Se2, Se3, Se4 and connection points 308 connect to ports of four network switches Sw1, Sw2, Sw3, Sw4. For example, each connection point 304 in row R1 connects to server Se1, each connection point 304 in row R2 connections to server Se2, each connection point 304 in row R3 connects to server Se3, and each connection point 304 in row R4 connects to server Se4. Meanwhile, each connection point 308 in column C1 connects to network switch Sw1, each connection point 308 in column C2 connects to network switch Sw2, each connection point 308 in column C3 connects to network switch Sw3, and each connection point 308 in column 4 connects to network switch Sw4. The ports of the servers Se comprise suitable ports for connecting a server to a connection point 304 for the purpose of transmitting signals (e.g., electrical or optical signals). The ports of the network switches Sw comprise suitable ports for connecting a network switch to a connection point 308 for the purpose of transmitting signals (e.g., electrical or optical signals). The ports of the servers Se, network switches Se, and connectors at the connection points 304 and 308 may be configured for accepting a suitable cable of a selected form factor (e.g., a 40 gigabit quad small form-factor pluggable (QSFP) cable, an octal SFP (OSFP) cable, and/or the like).

FIG. 3B shows the side view of the panel 302 for column C1 from FIG. 3A where cables 324 connect connection points 304 to respective servers Se while cables 328 connect connection points 308 to network switch Sw1. In the same manner shown for column C1, additional cables 324 exist to connect each connection point 304 in the other columns to servers Se and additional cables 328 exist to connect each connection point 308 in the other columns to network switches Sw. In at least one embodiment, each cable 324 has a substantially same length and each cable 328 has a substantially same length. As may be appreciated from FIG. 3B, the 2D arrays of connection points 304 and 308 enable the lengths of the transmission paths between each server Se and the network switch Sw1 to be relatively short and substantially the same, which reduces signal degradation caused by lengthy transmission lines, reduces or eliminates the risk of mechanical damage to fiber optic components (e.g., minimize or reduce the risk of fibers breaking in the chassis), and/or reduces or eliminates transmission latency differences caused by transmission lines of different lengths. The servers Se and the network switches Sw1 may be arranged in housing 332 (e.g., a chassis or rack) in any suitable manner (e.g., in a vertical or horizontal orientation). Although not explicitly shown, it should be understood that the housing 332 may further house network switches Sw2, Sw3, and S4. Notably, the orientation of the servers Se and network switches Sw in the chassis does not affect transmission line length so long as each interconnect 320 has substantially the same length, each cable 324 has substantially the same length, and each cable 328 has substantially the same length. Thus, the servers Se and/or the network switches may be arranged horizontally or vertically in the chassis.

In view of the description herein, it should be appreciated that first connection points 304 may be arranged on the first face 312 of the panel 302 in a first direction (e.g., x-direction), and that each first connection point 304 is connectable to a corresponding port of a single host device (e.g., a host device 116). In addition, second connection points 308 are arranged on the second face 316 of the panel 302 in the first direction, where each second connection point 308 is connected to a respective first connection point 304. In addition, each second connection point 308 is connectable to a corresponding port of a different network switch (an embodiment of a routing device 124) in a plurality of network switches that route traffic for the single host device.

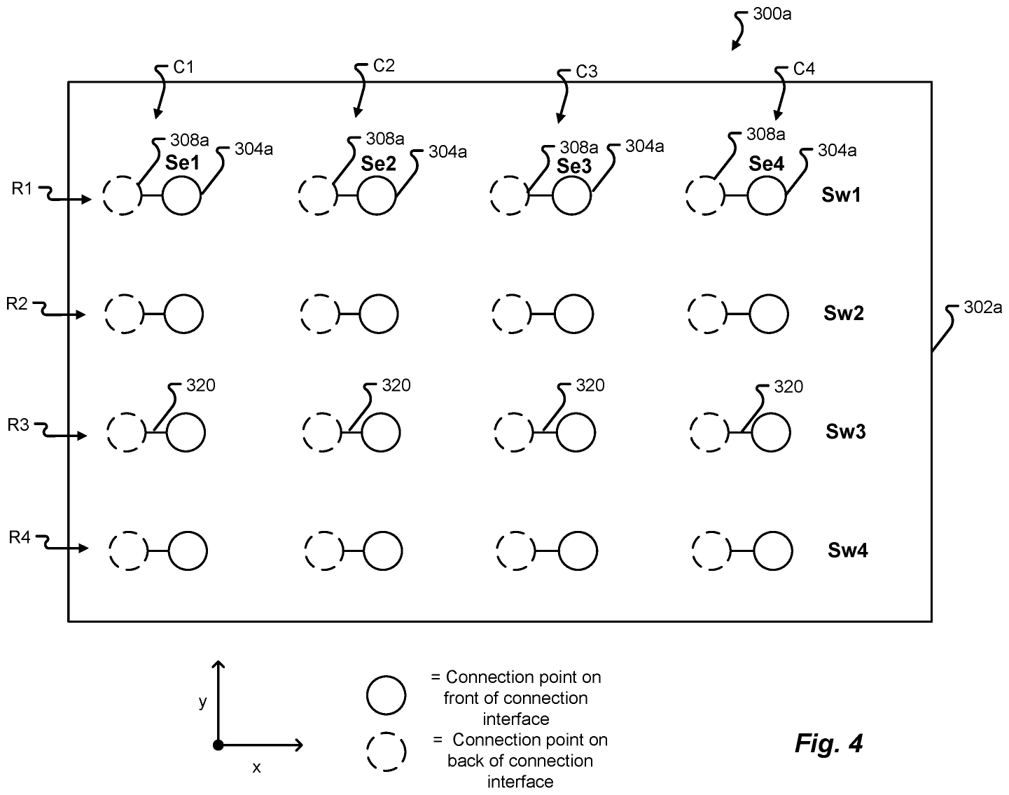

FIG. 4 illustrates a schematic plan view of an apparatus for interconnecting devices in a network according to at least one example embodiment. In general, the above discussion of FIGS. 1-3B also applies to FIG. 4. For example, FIG. 4 illustrates a connection interface 300a with a panel 302a having first connection points 304a and second connection points 308a. As in FIG. 3A, the first connection points 304a are included in a first 2D array of connection points arranged on a first face of the panel 302a, and the second connection points 308a are included in a second 2D array of connection points arranged on a second face of the panel 302a. As also in FIG. 3A, the connection points 304a to servers Se may still be arranged on a front face of the panel 302a while the connection points 308a may still be arranged on a back face of the panel 302a. However, comparing FIG. 4 to FIG. 3A, FIG. 4 shows that the first connection points 304a for each server Se are arranged in a y-direction (column direction) instead of an x-direction (row direction) and the second connection points 308a for each network switch Sw are arranged in the x-direction instead of the y-direction. The connection points 304a and 308a may comprise electrical and/or optical connectors that mechanically and communicatively couple to the servers Se and network switches Sw.

In view of FIG. 4, it may be said that each first connection point 304a in each row R of the first 2D array of connection points connects to a different host device (e.g., a different server Se), and each first connection point 304a in each column C of the first 2D array of connection points connects to a single host device (e.g., a single server Se). Meanwhile, each second connection point 308a in each row of the second 2D array connects to a single network switch Sw of the network switches, and each connection point 308a in each column of the second 2D array of connection points connects to a different network switch Sw from among the network switches. As in FIGS. 1-3B, the panel 302a may be included in a housing 332 and positioned between the servers Se and the network switches Sw.

In view of the description herein, example embodiments are directed to an apparatus for interconnecting devices in a network. The apparatus may include a host device 116 and network switches (e.g., routing devices 124) that route traffic for the host device 116. The apparatus may include a housing 332 that houses the host device and the network switches, a panel (e.g., 302) in the housing and positioned between the host device and the network switches. As described above, the panel includes first connection points arranged on the first face of the panel in a first direction, where each first connection point is connectable to a corresponding port of the host device. The panel further includes second connection points arranged on the second face of the panel in the first direction, where each second connection point is connected to a respective first connection point, and where each second connection point is connectable to a corresponding port of a different network switch in the network switches. In at least one embodiment, the first connection points are included in a first 2D array of connection points arranged on the first face of the panel, and the second connection points are included in a second 2D array of connection points arranged on the second face of the panel.

In some cases, the apparatus further includes additional host devices housed in the housing, where each first connection point (e.g., 304) in each column of the first 2D array of connection points connects to a different host device, and where each first connection point in each row of the first 2D array of connection points connects to a single host device. In addition, each second connection point (e.g., 308) in each column of the second 2D array connects to a single network switch of the network switches. Each second connection point in each row of the second 2D array of connection points connects to a different network switch from among the network switches.

In other cases, each first connection point (e.g., 304a) in each row of the first 2D array of connection points connects to a different host device, and each first connection point in each column of the first 2D array of connection points connects to a single host device. In this scenario, each second connection point (e.g. 308a) in each row of the second 2D array connects to a single network switch of the network switches, and each second connection point in each column of the second 2D array of connection points connects to a different network switch from among the network switches.

While example embodiments have been shown and described with respect to connecting host devices to routing devices with a connection interface, the connection interface may have other uses in a network system. For example, the connection interface may be used to connect a set of network switches with another set of network switches in the same or similar manner as described above. In this case, the host devices (e.g., servers) are substituted for an additional set of network switches.

Although example embodiments have been shown and described with respect to systems having specific types of elements, numbers of elements, sizes elements, and/or shapes of elements, it should be appreciated inventive concepts are not limited thereto and that fewer, additional, and/or different types of elements, numbers of elements, sizes elements, and/or shapes of elements are within the scope of inventive concepts. In addition, the connectors described herein may be implemented as female and/or male connectors as desired.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

It should be appreciated that inventive concepts cover any embodiment in combination with any one or more other embodiments, any one or more of the features disclosed herein, any one or more of the features as substantially disclosed herein, any one or more of the features as substantially disclosed herein in combination with any one or more other features as substantially disclosed herein, any one of the aspects/features/embodiments in combination with any one or more other aspects/features/embodiments, use of any one or more of the embodiments or features as disclosed herein. It is to be appreciated that any feature described herein can be claimed in combination with any other feature(s) as described herein, regardless of whether the features come from the same described embodiment.

Example embodiments may be configured as follows:
(1) An apparatus for interconnecting devices in a network, comprising:
a panel comprising a first face and a second face opposite the first face;
first connection points arranged on the first face of the panel in a first direction, wherein each first connection point is connectable to a corresponding port of a single host device; and
second connection points arranged on the second face of the panel in the first direction, wherein each second connection point is connected to a respective first connection point, and
wherein each second connection point is connectable to a corresponding port of a different network switch in a plurality of network switches that route traffic for the single host device.
(2) The apparatus of (1), wherein the first connection points are aligned with one another in the first direction.
(3) The apparatus of one or more of (1) to (2), wherein the second connection points are aligned with another in the first direction.
(4) The apparatus of one or more of (1) to (3), wherein the first connection points and the second connection points are arranged on the panel to overlap one another in a plan view.
(5) The apparatus of one or more of (1) to (4), further comprising:
a plurality of interconnects that connect the first connection points to the second connection points.
(6) The apparatus of one or more of (1) to (5), wherein the first connection points and the second connection points are arranged on the panel such that each of the plurality of interconnects travels a minimum distance between a respective first connection point and a respective second connection point.
(7) The apparatus of one or more of (1) to (6), wherein the plurality of interconnects pass through the panel.
(8) The apparatus of one or more of (1) to (7), wherein the plurality of interconnects comprise electrical interconnects, optical interconnects, or a combination of electrical interconnects and optical interconnects.
(9) The apparatus of one or more of (1) to (8), wherein the first connection points and the second connection points comprise electrical connectors, optical connectors, or a combination of electrical connectors and optical connectors.
(10) The apparatus of one or more of (1) to (9), wherein the panel is planar.
(11) An apparatus for interconnecting devices in a network, comprising:
a connection interface comprising a first face and a second face opposite the first face;
a first 2D array of first connection points arranged on the first face of the connection interface, wherein each first connection point in each column of the first 2D array connects to a different host device from among a plurality of host devices, and wherein each first connection point in each row of the first 2D array connects to a single host device from among the plurality of host devices; and
a second 2D array of second connection points arranged on the second face of the connection interface, wherein each second connection point is connected to a respective first connection point, wherein each second connection point in each column of the second 2D array connects to a single network switch from among a plurality of network switches, and wherein each second connection point in each row of the second 2D array connects to a different network switch from among the plurality of network switches.
(12) The apparatus of (11), wherein the connection interface comprises a planar panel.
(13) The apparatus of one or more of (11) to (12), wherein the first connection points and the second connection points comprise electrical connectors, optical connectors, or a combination of electrical connectors and optical connectors.
(14) The apparatus of one or more of (11) to (13), further comprising:
a plurality of interconnects that connect the first connection points to the second connection points, wherein the first connection points and the second connection points are arranged on the connection interface such that each of the plurality of interconnects travels a minimum distance between a respective first connection point and a respective second connection point.
(15) The apparatus of one or more of (11) to (14), wherein the first 2D array of the first connection points and the second 2D array of the second connection points are arranged on the connection interface to overlap one another in a plan view.
(16) An apparatus for interconnecting devices in a network, comprising:
a host device;
network switches that route traffic for the host device;
a housing that houses the host device and the network switches;
a panel in the housing and positioned between the host device and the network switches, the panel comprising a first face and a second face opposite the first face;
first connection points arranged on the first face of the panel in a first direction, wherein each first connection point is connectable to a corresponding port of the host device;
second connection points arranged on the second face of the panel in the first direction, wherein each second connection point is connected to a respective first connection point, and wherein each second connection point is connectable to a corresponding port of a different network switch in the network switches.
(17) The apparatus of (16), wherein the first connection points are included in a first 2D array of connection points arranged on the first face of the panel, and wherein the second connection points are included in a second 2D array of connection points arranged on the second face of the panel.
(18) The apparatus of one or more of (16) to (17), further comprising:
additional host devices housed in the housing, wherein each first connection point in each column of the first 2D array of connection points connects to a different host device, and wherein each first connection point in each row of the first 2D array of connection points connects to a single host device, and
wherein each second connection point in each column of the second 2D array connects to a single network switch of the network switches, and wherein each second connection point in each row of the second 2D array of connection points connects to a different network switch from among the network switches.
(19) The apparatus of one or more of (16) to (18), further comprising:
additional host devices housed in the housing, wherein each first connection point in each row of the first 2D array of connection points connects to a different host device, and wherein each first connection point in each column of the first 2D array of connection points connects to a single host device, and
wherein each second connection point in each row of the second 2D array connects to a single network switch of the network switches, and wherein each second connection point in each column of the second 2D array of connection points connects to a different network switch from among the network switches.
(20) The apparatus of one or more of (16) to (19), wherein the host device corresponds to a server.

What is claimed is:

1. An apparatus for interconnecting devices in a network, comprising:
a panel comprising a first face and a second face opposite the first face;
first connection points arranged on the first face of the panel in a first direction, wherein each first connection point is connectable to a corresponding port of a single host device; and
second connection points arranged on the second face of the panel in the first direction, wherein each second connection point is connected to a respective first connection point, and wherein each second connection point is connectable to a corresponding port of a different network switch in a plurality of network switches that route traffic for the single host device.

2. The apparatus of claim 1, wherein the first connection points are aligned with one another in the first direction.

3. The apparatus of claim 2, wherein the second connection points are aligned with another in the first direction.

4. The apparatus of claim 3, wherein the first connection points and the second connection points are arranged on the panel to overlap one another in a plan view.

5. The apparatus of claim 3, further comprising:
a plurality of interconnects that connect the first connection points to the second connection points.

6. The apparatus of claim 5, wherein the first connection points and the second connection points are arranged on the panel such that each of the plurality of interconnects travels a minimum distance between a respective first connection point and a respective second connection point.

7. The apparatus of claim 6, wherein the plurality of interconnects pass through the panel.

8. The apparatus of claim 5, wherein the plurality of interconnects comprise electrical interconnects, optical interconnects, or a combination of electrical interconnects and optical interconnects.

9. The apparatus of claim 1, wherein the first connection points and the second connection points comprise electrical connectors, optical connectors, or a combination of electrical connectors and optical connectors.

10. The apparatus of claim 1, wherein the panel is planar.

11. An apparatus for interconnecting devices in a network, comprising:
a connection interface comprising a first face and a second face opposite the first face;
a first 2D array of first connection points arranged on the first face of the connection interface, wherein each first connection point in each column of the first 2D array connects to a different host device from among a plurality of host devices, and wherein each first connection point in each row of the first 2D array connects to a single host device from among the plurality of host devices; and
a second 2D array of second connection points arranged on the second face of the connection interface, wherein each second connection point is connected to a respective first connection point, wherein each second connection point in each column of the second 2D array connects to a single network switch from among a plurality of network switches, and wherein each second connection point in each row of the second 2D array connects to a different network switch from among the plurality of network switches.

12. The apparatus of claim 11, wherein the connection interface comprises a planar panel.

13. The apparatus of claim 11, wherein the first connection points and the second connection points comprise electrical connectors, optical connectors, or a combination of electrical connectors and optical connectors.

14. The apparatus of claim 11, further comprising:
a plurality of interconnects that connect the first connection points to the second connection points, wherein the first connection points and the second connection points are arranged on the connection interface such that each of the plurality of interconnects travels a minimum distance between a respective first connection point and a respective second connection point.

15. The apparatus of claim 11, wherein the first 2D array of the first connection points and the second 2D array of the second connection points are arranged on the connection interface to overlap one another in a plan view.

16. An apparatus for interconnecting devices in a network, comprising:
a host device;
network switches that route traffic for the host device;
a housing that houses the host device and the network switches;
a panel in the housing and positioned between the host device and the network switches, the panel comprising a first face and a second face opposite the first face;
first connection points arranged on the first face of the panel in a first direction, wherein each first connection point is connectable to a corresponding port of the host device;
second connection points arranged on the second face of the panel in the first direction, wherein each second connection point is connected to a respective first connection point, and wherein each second connection point is connectable to a corresponding port of a different network switch in the network switches.

17. The apparatus of claim 16, wherein the first connection points are included in a first 2D array of connection points arranged on the first face of the panel, and wherein the second connection points are included in a second 2D array of connection points arranged on the second face of the panel.

18. The apparatus of claim 17, further comprising:
additional host devices housed in the housing, wherein each first connection point in each column of the first 2D array of connection points connects to a different host device, and wherein each first connection point in each row of the first 2D array of connection points connects to a single host device, and
wherein each second connection point in each column of the second 2D array connects to a single network switch of the network switches, and wherein each second connection point in each row of the second 2D array of connection points connects to a different network switch from among the network switches.

19. The apparatus of claim 17, further comprising:
additional host devices housed in the housing, wherein each first connection point in each row of the first 2D array of connection points connects to a different host device, and wherein each first connection point in each column of the first 2D array of connection points connects to a single host device, and
wherein each second connection point in each row of the second 2D array connects to a single network switch of the network switches, and wherein each second connection point in each column of the second 2D array of connection points connects to a different network switch from among the network switches.

20. The apparatus of claim 16, wherein the host device corresponds to a server.
